(19) United States
(12) Patent Application Publication
(10) Pub. No.: US 2020/0127883 A1
(43) Pub. Date: Apr. 23, 2020

(54) METHOD AND APPARATUS FOR BEAM FAILURE RECOVERY

(71) Applicant: Telefonaktiebolaget LM Ericsson (publ), Stockholm (SE)

(72) Inventors: Jinhua Liu, Beijing (CN); Min Wang, Luleå (SE)

(21) Appl. No.: 16/345,353

(22) PCT Filed: Jan. 11, 2019
(86) PCT No.: PCT/CN2019/071334

§ 371 Date: Apr. 26, 2019

(30) Foreign Application Priority Data
Jan. 11, 2018 (CN) PCT/CN2018/072250

(51) Int. Cl. H04L 12/24; H04W 72/04; H04W 76/38; H04W 74/08

(52) U.S. Cl. CPC H04L 41/0654; H04L 41/0806; H04W 74/0833; H04L 41/0686; H04W 76/38; H04W 72/0453

(57) ABSTRACT

Various embodiments of the present disclosure provide a method for handling beam failure recovery in a communication network. The method comprises detecting a beam failure in a serving cell of a terminal device. The terminal device is configured with carrier aggregation. The method further comprises determining, according to a predefined configuration, whether to transmit a report of the beam failure to a network node provisioning the serving cell to the terminal device, in response to the detection of the beam failure. According to the embodiments of the present disclosure, the beam failure recovery for a serving cell of a terminal device can be handled flexibly, so that system performance and energy efficiency of the communication network can be improved.

### FIELD OF THE INVENTION

The present disclosure generally relates to communication networks, and more specifically, to beam failure recovery (BFR) in a communication network.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, a wireless communication network, such as a long term evolution (LTE)/fourth generation (4G) network or a new radio (NR)/fifth generation (5G) network, may support carrier aggregation (CA) to achieve high system capacity and end-user data rates. Several component carriers may be aggregated by means of CA technology in order to increase transmission bandwidth. A user equipment (UE) may be configured with one primary component carrier (corresponding to a primary serving cell) and a number of secondary component carriers (corresponding to the respective secondary serving cells). According to specific agreements, up to 16 component carriers may be configured for a UE. The beam based radio links (also known as beam links for the sake of simplicity) on the respective component carriers may need to be maintained correspondingly, which poses higher requirements on processing capability and resource configuration of the UE. Thus, it is desirable to improve the beam link maintenance in CA applications.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a wireless communication network such as NR or LTE supporting CA technology, a UE may be configured with at least two serving cells including a primary serving cell (PCell) and one or more secondary serving cells (SCells). In order to ensure good communication quality and service performance, the UE may need to monitor a beam link in each cell and take appropriate recovery measures in the event of a beam failure. However, it may be costly to trigger BFR upon a beam failure in each cell. Therefore, there may be a need to handle the BFR of a serving cell in a more efficient way.

Various embodiments of the present disclosure propose a solution of handling BFR in a communication network, which can enable a terminal device to selectively report a beam failure to a network node serving the terminal device and triggering the BFR for the beam failure as required, so as to improve system performance and resource efficiency of the communication network.

According to a first aspect of the present disclosure, there is provided a method performed by a terminal device. The method comprises detecting a beam failure in a serving cell of the terminal device. The terminal device is configured with CA. The method further comprises determining, according to a predefined configuration, whether to transmit a report of the beam failure to a network node provisioning the serving cell to the terminal device, in response to the detection of the beam failure.

In accordance with an exemplary embodiment, the method according to the first aspect of the present disclosure may further comprise transmitting the report of the beam failure to the network node, in response to determining that the report is to be transmitted to the network node.

In accordance with an exemplary embodiment, the method according to the first aspect of the present disclosure may further comprise starting a timer for the beam failure, in response to the transmission of the report to the network node.

In accordance with an exemplary embodiment, the method according to the first aspect of the present disclosure may further comprise determining whether a configuration message is received from the network node prior to expiration of the timer. The configuration message indicates the terminal device to perform a BFR procedure for the serving cell.

In accordance with an exemplary embodiment, the method according to the first aspect of the present disclosure may further comprise performing the BFR procedure according to the configuration message, in response to determining that the configuration message is received prior to the expiration of the timer.

In accordance with an exemplary embodiment, the method according to the first aspect of the present disclosure may further comprise inactivating the serving cell by releasing one or more radio resources configured for the serving cell, in response that the timer is expired while the configuration message is not received from the network node.

In accordance with an exemplary embodiment, the method according to the first aspect of the present disclosure may further comprise monitoring the serving cell prior to the expiration of the timer to detect a recovery of the beam failure.

In accordance with an exemplary embodiment, the method according to the first aspect of the present disclosure may further comprise: in response to the detection of the recovery prior to the reception of the configuration message, sending a notification of the recovery of the beam failure to the network node and setting the timer as expired.

In accordance with an exemplary embodiment, the method according to the first aspect of the present disclosure may further comprise performing a BFR procedure for the serving cell, in response to determining that the report is not to be transmitted to the network node.

According to a second aspect of the present disclosure, there is provided an apparatus which may be implemented as a terminal device. The apparatus comprises one or more processors and one or more memories comprising computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a terminal device. The apparatus comprises a detecting unit and a determining unit. In accordance with some exemplary embodiments, the detecting unit may be operable to carry out at least the detecting step of the method according to the first aspect of the present disclosure. The determining unit may be operable to carry out at least the determining step of the method according to the first aspect of the present disclosure.

According to a fifth aspect of the present disclosure, there is provided a method performed by a network node. The method comprises provisioning a serving cell to a terminal device configured with CA. The method further comprises receiving a report of a beam failure in the serving cell transmitted from the terminal device according to a predefined configuration.

In accordance with an exemplary embodiment, the method according to the fifth aspect of the present disclosure may further comprise determining whether to transmit a configuration message to the terminal device based at least in part on the report of the beam failure. The configuration message indicates the terminal device to perform a BFR procedure for the serving cell.

In accordance with an exemplary embodiment, the method according to the fifth aspect of the present disclosure may further comprise transmitting the configuration message to the terminal device, in response to determining that the configuration message is to be transmitted to the terminal device.

In accordance with an exemplary embodiment, the method according to the fifth aspect of the present disclosure may further comprise receiving a notification of a recovery of the beam failure from the terminal device.

According to a sixth aspect of the present disclosure, there is provided an apparatus which may be implemented as a network node. The apparatus comprises one or more processors and one or more memories comprising computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a network node. The apparatus comprises a provisioning unit and a receiving unit. In accordance with some exemplary embodiments, the provisioning unit may be operable to carry out at least the provisioning step of the method according to the fifth aspect of the present disclosure. The receiving unit may be operable to carry out at least the receiving step of the method according to the fifth aspect of the present disclosure.

In accordance with an exemplary embodiment, the predefined configuration may indicate the terminal device to transmit the report of the beam failure to the network node in response that the beam failure is detected in a secondary serving cell of the terminal device.

Alternatively or additionally, the predefined configuration may indicate the terminal device not to transmit the report of the beam failure to the network node in response that the beam failure is detected in one of a PCell of the terminal device and a SCell, configured with a control channel, of the terminal device.

In accordance with an exemplary embodiment, the report may comprise at least one of the following: an index of the serving cell, an index of a carrier corresponding to the serving cell, an indicator of the beam failure, an index of a beam having the beam failure, and one or more candidate beams available for a BFR procedure in the serving cell.

In accordance with an exemplary embodiment, the configuration message may comprise at least one of the following: an index of the serving cell, an indicator of a random access scheme applicable to the BFR procedure, a preamble for random access, and one or more radio resources for random access transmissions.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fifth aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a twelfth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a flowchart illustrating a method according to some embodiments of the present disclosure;

FIG. 2 is a flowchart illustrating another method according to some embodiments of the present disclosure;

FIG. 3 is a flowchart illustrating an exemplary handling procedure of BFR according to an embodiment of the present disclosure;

FIG. 4 is a block diagram illustrating an apparatus according to some embodiments of the present disclosure;

FIG. 5 is a block diagram illustrating an apparatus according to some embodiments of the present disclosure;

FIG. 6 is a block diagram illustrating an apparatus according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

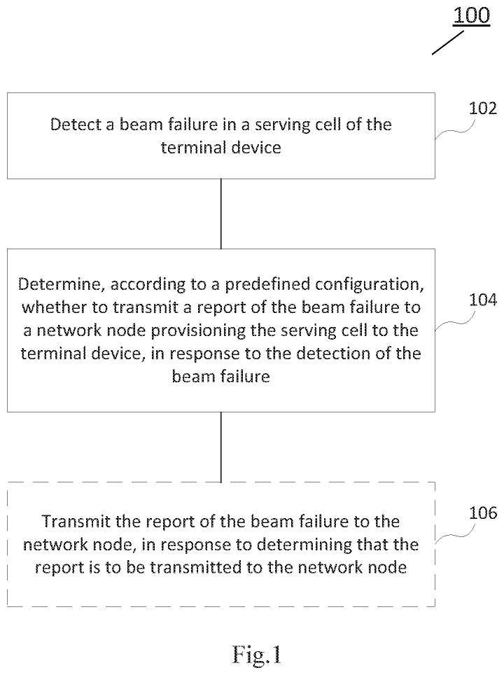

FIG. 1 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HISPA), and so on. Furthermore, the communications between a terminal device and a network node in the communication network may be performed according to any suitable generation communication protocols, including, but not limited to, the first generation (I G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an IoT scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3GPP context be referred to as a machine-type communication (MTC) device.

As one particular example, the terminal device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

In a wireless communication network such as LTE or NR, beam link maintenance and/or radio link maintenance may be adopted to fulfill various requirements of data transmissions over the links. The radio link maintenance may be performed based on a radio link monitoring procedure. A number of measurements, such as hypothetical physical downlink control channel (PDCCH) block error rate (BLER), radio link control (RLC) retransmissions in RLC acknowledgement mode and a random access failure to a target cell during handover, may be obtained through the radio link monitoring procedure. A UE can determine a radio link failure (RLF) according to these measurements. A gNB also can determine a RLF based at least in part on certain proprietary solutions, for example, the poor uplink (UL) radio channel quality, etc.

When a UE determines a RLF, it may release the configured radio resources, such as physical uplink control channel (PUCCH) resources, configured semi-static UL grants or downlink (DL) assignments, channel state information-reference signals (CSI-RS), sounding reference signals (SRS), demodulation reference signals (DMRS), etc., then skip the dynamic grants from its serving cell, and start a radio connection re-establishment procedure. In the radio connection re-establishment procedure, the UE can first select a target cell and then perform random access to the target cell. For example, a cell-radio network temporary identifier (C-RNTI) for the UE may be reported to the target cell in message 3 via a medium access control (MAC) control element (CE), so that the target cell can identify, the UE and fetch the UE context. After the random access to the target cell is successful, various radio resources may be reconfigured for the UE.

Similarly, the beam link maintenance may be performed based on a beam link monitoring procedure. A UE can monitor the beam link quality based on the hypothetical BLER of PDCCH. For instance, a beam failure can be determined in the case that the beam link quality is worse than a predefined threshold for a number of times. In accordance with an exemplary embodiment, a BFR procedure may be triggered for the determined beam failure. The UE may perform contention based random access (CBRA) or contention free random access (CFRA) in the BFR procedure, according to a predefined network configuration for the UE.

In the case of CFRA, some dedicate physical random access charnel (PRACH) resource (for example, a preamble and optionally a special time-frequency resource for PRACH transmission) may be preconfigured or assigned to the UE. When a beam failure is determined, the UE can perform a PRACH transmission to its serving gNB. Upon the reception of the specific PRACH transmission, the gNB may be able to know which UE requests BFR according to the PRACH information (for example, a PRACH preamble index plus the PRACH radio resource), and then the gNB can respond to the UE by using a PDCCH addressed to the C-RNTI for the UE.

Compared to the radio connection re-establishment upon RLF, various radio resources (such as PUCCH resources, configured grant/assignment, CSI-RS, SRS, DMRS, PDCCH resources, etc.) configured for the UE would not be released upon the beam failure. The UE can continue with the original radio resource configurations after the BFR procedure, which can minimize the service interruption.

However, for a UE configured with multiple SCells in the case of CA, it may be costly to configure one or more dedicated PRACH resources (for example, a PRACH preamble and/or time-frequency resources for PRACH transmissions) for the CFRA for each SCell. In one aspect, a UE may take too many PRACH preambles for its SCells. In another aspect, a gNB may have to always monitor the PRACH transmissions for many SCells due to the BFR is unpredictable. Hence there may be problems such as the PRACH resource shortage for the network and the processing power bottleneck in the gNB.

In accordance with some exemplary embodiments, the present disclosure provides a solution to enable a terminal device (such as a UE) to handle BFR according to a predefined configuration. According to the proposed solution, the terminal device may report a beam failure to a network node (such as a serving gNB/eNB of the UE) instead of triggering a BFR procedure, in response to the detection of the beam failure in a serving cell of the terminal device. Correspondingly, the network node can determine whether to configure the terminal device to perform a BFR procedure for the reported beam failure. Optionally, the network node may notify the terminal device to execute the BFR procedure, and possibly provide some configuration information to the terminal device via a special message such as a PDCCH order, a MAC CE or radio resource control (RRC) signaling.

Alternatively or additionally, according to the proposed solution, it also may be allowable not to report the detected beam failure to the network node, if the beam failure occurs in a specific serving cell such as a PCell or a PUCCH SCell of the terminal device. In this case, the terminal device may autonomously trigger a BFR procedure for the specific serving cell and perform the preconfigured random access scheme.

Many advantages may be achieved by applying the proposed solution according to the present disclosure. For example, configuring PRACH resources for BFR on the basis of the reported beam failure in a serving cell can decrease the resource consumption of BFR, compared to the CFRA based BFR for each serving cell. From the perspective of a UE, it may not be necessary to always trigger BFR upon a beam failure. Instead, the UE can perform the BFR according to the configuration from its serving gNB, or release radio resources occupied by the failed beam. This can enhance energy efficiency and resource utilization. On the other hand, the proposed solution can greatly reduce the processing complexity to handle the random access procedure in a gNB, because the gNB can predict the PRACH transmissions due to its configuration of PRACH resources for the BFR. The above benefits could be extremely meaningful in the case of high network load.

It is noted that some embodiments of the present disclosure are mainly described in relation to LTE or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does not limit the present disclosure naturally in any way. Rather, any other system configuration or radio technologies may equally be utilized as long as exemplary embodiments described herein are applicable.

FIG. 1 is a flowchart illustrating a method 100 according to some embodiments of the present disclosure. The method 100 illustrated in FIG. 1 may be performed by a terminal device or an apparatus communicatively coupled to the terminal device. In accordance with an exemplary embodiment, the terminal device such as a UE can support CA and may be allocated two or more components carriers for communication with a network node such as a serving gNB/eNB of the UE. In this regard, the terminal device may be provisioned with two or more serving cells (for example, a PCell and one or more SCells) by the network node. The respective beam links in the two or more serving cells may be maintained by the terminal device.

According to the exemplary method 100 illustrated in FIG. 1, the terminal device may detect a beam failure in a serving cell of the terminal device, as shown in block 102. For example, the terminal device, which is configured with CA, can monitor the beam link quality of the serving cell. If the beam link quality is worse than a quality threshold for a certain number of times, a beam failure may occur in the serving cell. In accordance with an exemplary embodiment, the serving cell may comprise a PCell or a SCell of the terminal device. Different types of serving cells may be configured with the same or different quality thresholds and parameters settings.

In response to the detection of the beam failure, the terminal device can determine, according to a predefined configuration, whether to transmit a report of the beam failure to a network node provisioning the serving cell to the terminal device, as shown in block 104. The predefined configuration can make the terminal device to know in which cases it may be not necessary to report the detected beam failure to the network node, and/or in which cases the beam failure may need to be reported to the network node. A variety of potential factors, for example, the importance of a serving cell to the terminal device, the processing capability of the terminal device, etc., may be considered when specifying the predefined configuration.

In accordance with an exemplary embodiment, the predefined configuration may indicate the terminal device to transmit the report of the beam failure to the network node in response that the beam failure is detected in a SCell of the terminal device. Alternatively or additionally, the predefined configuration may indicate the terminal device not to transmit the report of the beam failure to the network node in response that the beam failure is detected in a specific serving cell. For example, the specific serving cell may comprise a PCell of the terminal device, a SCell configured with a control channel such as a PUCCH (which may be referred to as PUCCH SCell) of the terminal device, or any other serving cell with a high maintenance priority for the terminal device. The SCell configured with a control channel of the terminal device may be used for uplink control information transmission and possibly data transmission of the terminal device. Optionally, the predefined configuration also may indicate the terminal device to transmit the report of the beam failure to the network node in response to the detection of the beam failure, regardless of in which serving cell the beam failure is detected.

In an exemplary embodiment where the terminal device determines not to transmit the report to the network node according to the predefined configuration, the terminal device may perform a BFR procedure for the serving cell. For example, if the beam failure is detected in a PUCCH SCell of the terminal device, then according to the predefined configuration, the terminal device may trigger the BFR procedure autonomously without reporting the beam failure to the network node. In this case, a random access scheme (such as CFRA or CBRA) may be preconfigured for the BFR procedure. Accordingly, the terminal device can perform the preconfigured random access scheme in the BFR procedure for the PUCCH SCell.

Alternatively, according to the exemplary method 100 illustrated in FIG. 1, the terminal device may transmit the report of the beam failure to the network node, in response to determining that the report is to be transmitted to the network node, as shown in block 106. The report may be carried in a MAC CE or a RRC signaling message. In accordance with an exemplary embodiment, the report may comprise at least one of the following: an index of the serving cell, an index of a carrier corresponding to the serving cell, an indicator of the beam failure, an index of a beam having the beam failure, and one or more candidate beams available for a BFR procedure in the serving cell. According to an exemplary embodiment, a candidate beam may comprise a beam of which the measured DL quality (for example, in terms of synchronization signal (SS)/CSI-RS-reference signal received power (RSRP), reference signal received quality (RSRQ), signal to interference plus noise ratio (SINR), etc.) is above a certain threshold.

For the reported beam failure, if the network node decides to configure the terminal device to trigger the corresponding BFR procedure, a configuration message may be transmitted from the network node to the terminal device, for example, in a RRC signaling message, a MAC CE or PDCCH order. Otherwise, the network node may not respond to the report of the beam failure from the terminal device.

According to an exemplary embodiment, in response to the transmission of the report to the network node, the terminal device may start a timer for the beam failure. The timer may be used for timing the period during which a configuration message may be expected to be received from the network node. The terminal device may keep the radio resources configured for the serving cell (for example, the configured semi-static UL grants or DL assignments, PUCCH resources, CSI-RS, SRS, DMRS, etc.) before the timer is expired.

In accordance with an exemplary embodiment, the terminal device may determine whether a configuration message is received from the network node prior to expiration of the timer. The configuration message may indicate the terminal device to perform a BFR procedure for the serving cell in which the beam failure is detected. According to an exemplary embodiment, the configuration message may comprise at least one of the following: an index of the serving cell, an indicator of a random access scheme (such as CFRA or CBRA) applicable to the BFR procedure, a preamble for random access (for example, a PRACH preamble in case CFRA is configured), and one or more radio resources for random access transmissions (for example, time-frequency resources for PRACH transmissions).

In response to determining that the configuration message is received prior to the expiration of the timer, the terminal device may perform the BFR procedure according to the configuration message. Optionally, the timer may be stopped upon the reception of the configuration message. According to an exemplary embodiment, in the case that the CFRA is configured for the BFR procedure by the network node, the terminal device may perform the BFR procedure for the serving cell based on the CFRA. Alternatively, if the CBRA is configured for the BFR procedure, the terminal device may perform the CBRA accordingly in the BFR procedure for the serving cell.

Alternatively, in response that the timer is expired while the configuration message is not received from the network node, the terminal device may inactivate the serving cell by releasing one or more radio resources configured for the serving cell. It can be seen that even if the network node does send the configuration message to the terminal device, the BFR procedure may not be performed by the terminal device to recover the failed beam link for the serving cell, as the terminal device cannot receive the configuration message in time. In order to avoid waste of resources, various factors may need to be taken into account to set the reasonable expiration time of the timer.

There may be another possible case where the beam failure may be recovered without the configuration message from the network node to configure the corresponding BFR procedure. The terminal device can monitor the serving cell prior to the expiration of the timer to detect a recovery of the beam failure, according to an exemplary embodiment. In response to the detection of the recovery prior to the reception of the configuration message, the terminal device can send a notification of the recovery of the beam failure to the network node and set the timer as expired (or stop the timer). In this case, although the network node may still send the configuration message to the terminal device, the configuration message would be ignored by the terminal device due to the expiration of the timer.

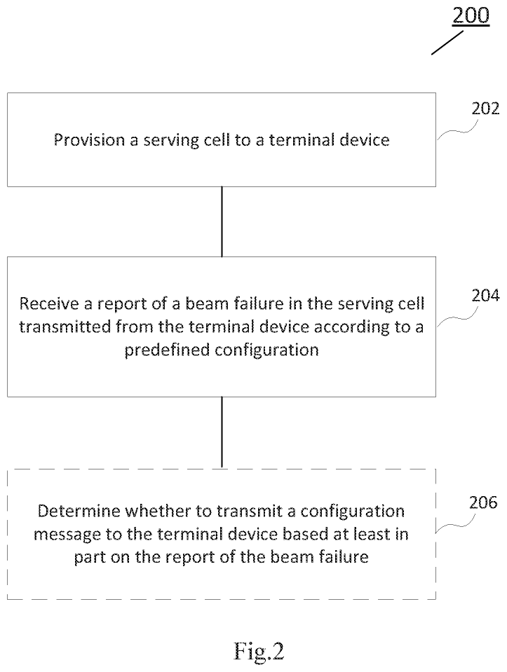

FIG. 2 is a flowchart illustrating a method 200 according to some embodiments of the present disclosure. The method 200 illustrated in FIG. 2 may be performed by a network node or an apparatus communicatively coupled to the network node. In accordance with an exemplary embodiment, the network node such as a gNB/eNB can support CA and may be configured to serve a terminal device as described with respect to FIG. 1.

According to the exemplary method 200 illustrated in FIG. 2, the network node can provision a serving cell to a terminal device such as a UE, as shown in block 202. The serving cell may comprise a PCell or a SCell of the terminal device configured with CA. Corresponding to operations of the exemplary method 100 as illustrated in FIG. 1, the network node in the exemplary method 200 may receive a report of a beam failure in the serving cell transmitted from the terminal device according to a predefined configuration, as shown in block 204.

As described previously, the terminal device may learn from the predefined configuration whether to report the detected beam failure to the network node. For example, if the beam failure is detected in a PCell or a SCell, configured with a control channel, of the terminal device, the network node would not receive the report of the beam failure. Otherwise, the beam failure may be reported to the network node.

In accordance with an exemplary embodiment, the network node can obtain some information related to the beam failure from the report, for example, comprising an index of the serving cell, an index of a carrier corresponding to the serving cell, an indicator of the beam failure, an index of a beam having the beam failure, one or more candidate beams available for a BFR procedure in the serving cell, and/or the like.

Based at least in part on the report of the beam failure, the network node can determine whether to transmit a configuration message to the terminal device, as shown in block 206. The configuration message may indicate the terminal device to perform a BFR procedure for the serving cell. In response to determining that the configuration message is to be transmitted to the terminal device, the network node can transmit the configuration message to the terminal device. As described in connection with FIG. 1, the configuration message may comprise an index of the serving cell, an indicator of a random access scheme applicable to the BFR procedure, a preamble for random access, one or more radio resources for random access transmissions, or any combination thereof.

According to an exemplary embodiment, if it is found that the serving cell having the beam failure is a serving cell with poor communication quality or low priority, the network node may determine not to transmit the configuration message to the terminal device. Alternatively or additionally, in the case that the network node does not have sufficient radio resources for configuring the BFR procedure in the serving cell for the terminal device, no configuration message may be transmitted from the network node to the terminal device.

Optionally, the network node may receive a notification of a recovery of the beam failure from the terminal device. In accordance with an exemplary embodiment, the transmission of the configuration message may be independent of the reception of the notification. In this case, the network node can still transmit the configuration message to the terminal device, for example, for other purpose such as timing advance measurement for the terminal device, even if the network node is notified that the beam failure is recovered. Alternatively, in order to save energy and improve efficiency, the network node may choose not to transmit the configuration message to the terminal device, if the notification is received by the network node before the transmission of the configuration message.

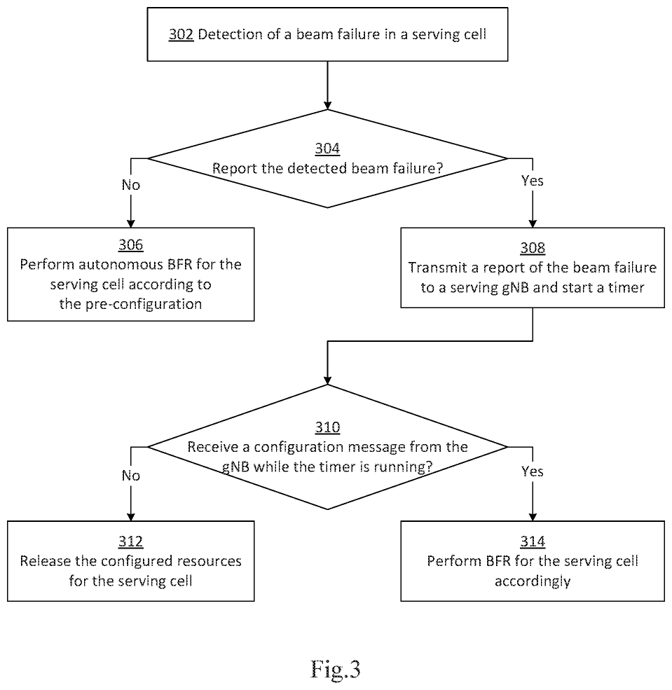

FIG. 3 is a flowchart illustrating an exemplary handling procedure of BFR according to an embodiment of the present disclosure. The exemplary handling procedure illustrated in FIG. 3 may be performed by a UE which can support CA in a wireless communication network. According to the exemplary procedure shown in FIG. 3, when a beam failure is detected 302 in a serving cell of the UE, the UE can select to report the beam failure to its serving gNB or directly trigger BFR of the serving cell without reporting the beam failure to the gNB.

As shown in FIG. 3, the UE can determine 304 whether to report the detected beam failure to its serving gNB, for example, according to a predefined configuration as described in connection with FIG. 1 and FIG. 2. If it is determined not to report the detected beam failure to the serving gNB (as shown in “No” branch of block 304), the UE can perform 306 autonomous BFR for the serving cell according to the pre-configuration. In accordance with an exemplary embodiment, the pre-configuration may indicate that the BFR is based on CFRA or CBRA. Optionally, some radio resources available for the BFR also may be specified in the pre-configuration.

Alternatively, if it is determined to report the detected beam failure to the serving gNB (as shown in “Yes” branch of block 304), the UE can transmit 308 a report of the beam failure to its serving gNB, for example, via a MAC CE or a RRC signaling message, and start a timer for BFR. The report may comprise some information related to the beam failure so that the serving gNB can determine whether to configure the BFR for the serving cell of the UE. If it is determined to recover the failed beam link for the serving cell of the UE, the serving gNB can send a configuration message to the UE, so that the UE can be configured to perform the BFR based on CFRA or CBRA for the serving cell. Otherwise, the serving gNB may not send any response to the report of the beam failure.

According to the exemplary procedure shown in FIG. 3, if the configuration message from the gNB is received by the UE while the timer is running (which means that the timer is not expired), as shown in “Yes” branch of block 310, the UE can perform 314 the BFR for the serving cell accordingly and stop the timer. However, if the UE does not receive the configuration message from the serving gNB until the timer expires, as shown in “No” branch of block 310, the UE may release 312 the configured resources for the serving cell. As such, the serving cell may turn into inactive from the perspective of the LE.

The proposed solution according to one or more exemplary embodiments can enable BFR for a serving cell of a UE to be handled flexibly. Taking the advantage of the proposed solution makes it possible to configure radio resources for the BFR by a serving gNB of the UE on demand. In this way, the processing complexity to maintain a beam link may be reduced, and radio resources may be efficiently utilized both at the network side and the terminal side.

The various blocks shown in FIG. 1-3 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

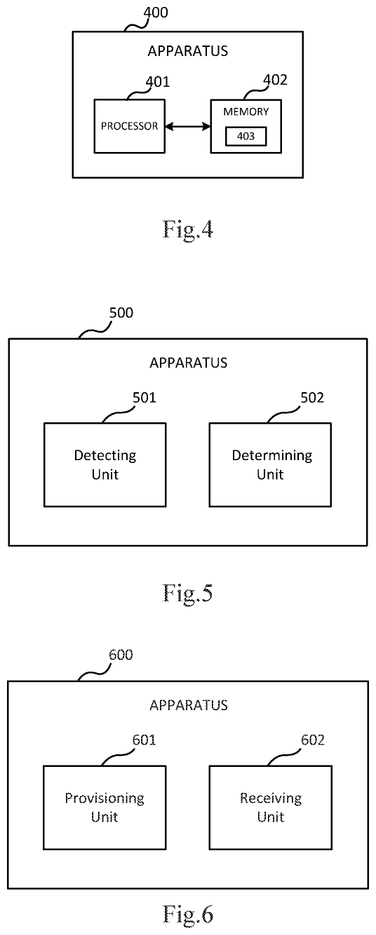

FIG. 4 is a block diagram illustrating an apparatus 400 according to various embodiments of the present disclosure. As shown in FIG. 4, the apparatus 400 may comprise one or more processors such as processor 401 and one or more memories such as memory 402 storing computer program codes 403. The memory 402 may be non-transitory machine/processor/computer readable storage medium. In accordance with some exemplary embodiments, the apparatus 400 may be implemented as an integrated circuit chip or module that can be plugged or installed into a terminal device as described with respect to FIG. 1, or a network node as described with respect to FIG. 2. In such case, the apparatus 400 may be implemented as a terminal device as described with respect to FIG. 1, or a network node as described with respect to FIG. 2.

In some implementations, the one or more memories 402 and the computer program codes 403 may be configured to, with the one or more processors 401, cause the apparatus 400 at least to perform any operation of the method as described in connection with FIG. 1. In other implementations, the one or more memories 402 and the computer program codes 403 may be configured to, with the one or more processors 401, cause the apparatus 400 at least to perform any operation of the method as described in connection with FIG. 2.

Alternatively or additionally, the one or more memories 402 and the computer program codes 403 may be configured to, with the one or more processors 401, cause the apparatus 400 at least to perform more or less operations to implement the proposed methods according to the exemplary embodiments of the present disclosure.

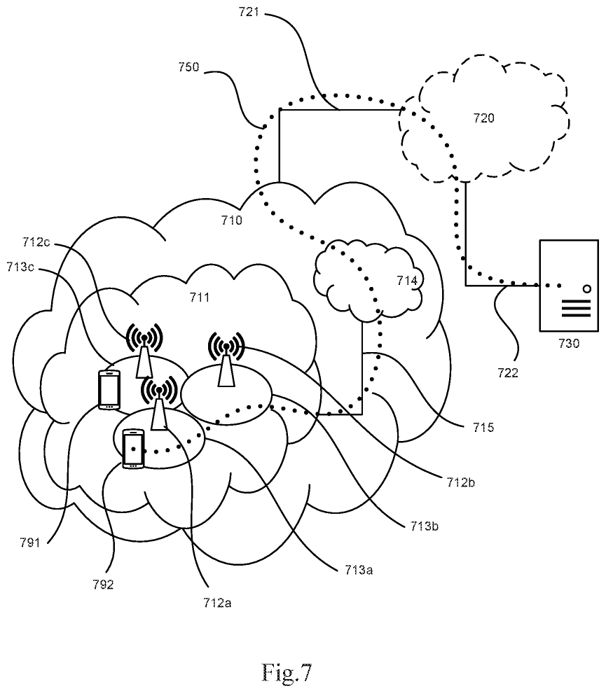

FIG. 5 is a block diagram illustrating an apparatus 500 according to some embodiments of the present disclosure. As shown in FIG. 5, the apparatus 500 may comprise a detecting unit 501 and a determining unit 502. In an exemplary embodiment, the apparatus 500 may be implemented in a terminal device such as a UE. The detecting unit 501 may be operable to carry out the operation in block 102, and the determining unit 502 may be operable to carry out the operation in block 104. Optionally, the detecting unit 501 and/or the determining unit 502 may be operable to carry out more or less operations to implement the proposed methods according to the exemplary embodiments of the present disclosure.

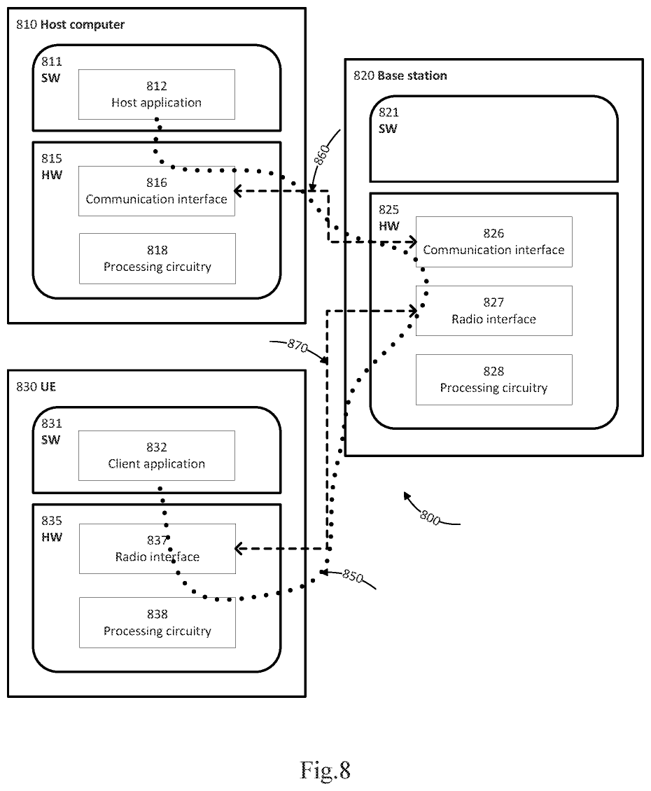

FIG. 6 is a block diagram illustrating an apparatus 600 according to some embodiments of the present disclosure. As shown in FIG. 6, the apparatus 600 may comprise a provisioning unit 601 and a receiving unit 602. In an exemplary embodiment, the apparatus 600 may be implemented in a network node such as a gNB/eNB. The provisioning unit 601 may be operable to carry out the operation in block 202, and the receiving unit 602 may be operable to carry out the operation in block 204. Optionally, the provisioning unit 601 and/or the receiving unit 602 may be operable to carry out more or less operations to implement the proposed methods according to the exemplary embodiments of the present disclosure.

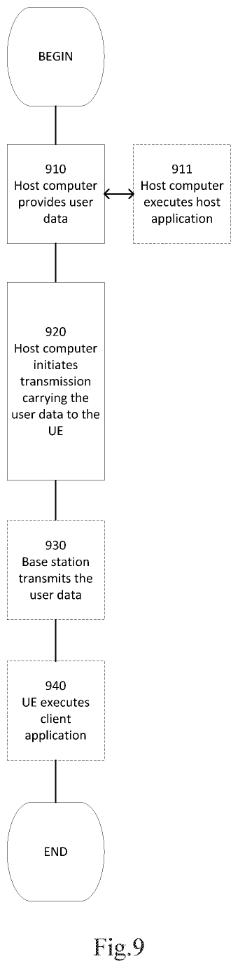

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

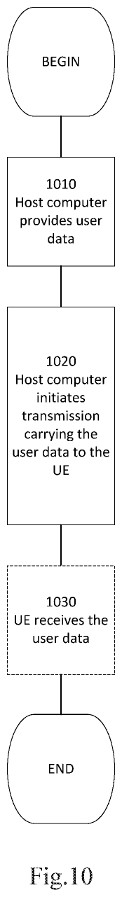

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

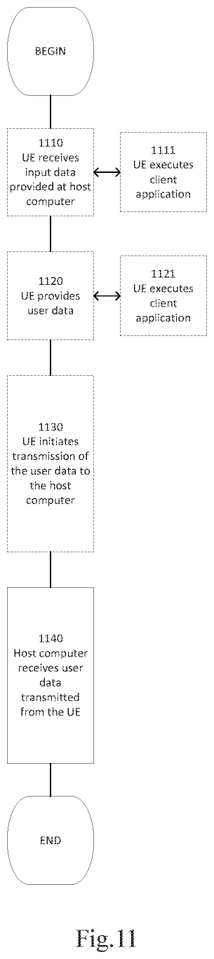

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

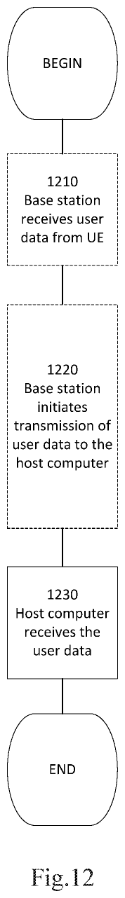

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program module modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a terminal device, comprising:
detecting a beam failure in a serving cell of the terminal device, the terminal device being configured with carrier aggregation; and
determining, according to a predefined configuration, whether to transmit a report of the beam failure to a network node provisioning the serving cell to the terminal device, in response to the detection of the beam failure.

2. The method according to claim 1, wherein the predefined configuration indicates the terminal device to transmit the report of the beam failure to the network node in response that the beam failure is detected in a secondary serving cell of the terminal device.

3. The method according to claim 1, wherein the predefined configuration indicates the terminal device not to transmit the report of the beam failure to the network node in response that the beam failure is detected in one of a primary serving cell of the terminal device and a secondary serving cell, configured with a control channel, of the terminal device.

4. The method according to claim 1, further comprising:
transmitting the report of the beam failure to the network node, in response to determining that the report is to be transmitted to the network node.

5. The method according to claim 1, wherein the report comprises at least one of the following:
an index of the serving cell;
an index of a carrier corresponding to the serving cell;
an indicator of the beam failure;
an index of a beam having the beam failure; and
one or more candidate beams available for a beam failure recovery procedure in the serving cell.

6. The method according to claim 4, further comprising:
starting a timer for the beam failure, in response to the transmission of the report to the network node; and
determining whether a configuration message is received from the network node prior to expiration of the timer, wherein the configuration message indicates the terminal device to perform a beam failure recovery procedure for the serving cell.

7. The method according to claim 6, further comprising:
performing the beam failure recovery procedure according to the configuration message, in response to determining that the configuration message is received prior to the expiration of the timer.

8. The method according to claim 6, further comprising:
monitoring the serving cell prior to the expiration of the timer to detect a recovery of the beam failure;
sending a notification of the recovery of the beam failure to the network node, in response to the detection of the recovery prior to the reception of the configuration message; and
setting the timer as expired.

9. The method according to claim 6, further comprising:
inactivating the serving cell by releasing one or more radio resources configured for the serving cell, in response that the timer is expired while the configuration message is not received from the network node.

10. The method according to claim 6, wherein the configuration message comprises at least one of the following:
an index of the serving cell;
an indicator of a random access scheme applicable to the beam failure recovery procedure;
a preamble for random access; and
one or more radio resources for random access transmissions.

11. The method according to claim 1, further comprising:
performing a beam failure recovery procedure for the serving cell, in response to determining that the report is not to be transmitted to the network node.

12. A terminal device, comprising:
one or more processors; and
one or more memories comprising computer program codes,
the one or more memories and the computer program codes configured to, with the one or more processors, cause the terminal device at least to:
detect a beam failure in a serving cell of the terminal device, the terminal device being configured with carrier aggregation; and
determine, according to a predefined configuration, whether to transmit a report of the beam failure to a network node provisioning the serving cell to the terminal device, in response to the detection of the beam failure.

13. (canceled)

14. A method performed by a network node, comprising:
provisioning a serving cell to a terminal device configured with carrier aggregation; and
receiving a report of a beam failure in the serving cell transmitted from the terminal device according to a predefined configuration.

15. The method according to claim 14, wherein the predefined configuration indicates the terminal device to transmit the report of the beam failure to the network node in response that the beam failure is detected in a secondary serving cell of the terminal device.

16. The method according to claim 14, wherein the predefined configuration indicates the terminal device not to transmit the report of the beam failure to the network node in response that the beam failure is detected in one of a primary serving cell of the terminal device and a secondary serving cell, configured with a control channel, of the terminal device.

17. The method according to claim 14, wherein the report comprises at least one of the following:
an index of the serving cell;
an index of a carrier corresponding to the serving cell;
an indicator of the beam failure;
an index of a beam having the beam failure; and
one or more candidate beams available for a beam failure recovery procedure in the serving cell.

18. The method according to claim 14, further comprising:
determining whether to transmit a configuration message to the terminal device based at least in part on the report of the beam failure, wherein the configuration message indicates the terminal device to perform a beam failure recovery procedure for the serving cell.

19. The method according to claim 18, further comprising:
transmitting the configuration message to the terminal device, in response to determining that the configuration message is to be transmitted to the terminal device.

20. The method according to claim 18, wherein the configuration message comprises at least one of the following:
an index of the serving cell;
an indicator of a random access scheme applicable to the beam failure recovery procedure;
a preamble for random access; and
one or more radio resources for random access transmissions.

21-27. (canceled)

28. The terminal device according to claim 12, wherein the predefined configuration indicates the terminal device to transmit the report of the beam failure to the network node in response that the beam failure is detected in a secondary serving cell of the terminal device.

29. The terminal device according to claim 12, wherein the predefined configuration indicates the terminal device not to transmit the report of the beam failure to the network node in response that the beam failure is detected in one of a primary serving cell of the terminal device and a secondary serving cell, configured with a control channel, of the terminal device.
